(19) United States
(12) Patent Application Publication
(10) Pub. No.: US 2011/0228184 A1
(43) Pub. Date: Sep. 22, 2011

(54) PROTECTIVE EYEWEAR INCORPORATING 3D LENSES FOR USE WITH A 3D VISUALIZATION SYSTEM

(76) Inventor: John E. Kennedy, Lowell, MA (US)

(21) Appl. No.: 13/046,546

(22) Filed: Mar. 11, 2011

Related U.S. Application Data
(60) Provisional application No. 61/313,213, filed on Mar. 12, 2010.

(51) Int. Cl. G02B 27/26; G02B 27/22; G02F 1/13357

(52) U.S. Cl. 349/15; 359/464; 359/465

(57) ABSTRACT

Protective eyewear for protecting the eyes of a user, the protective eyewear comprising:
at least one transparent surface for disposition in front of the eyes of the user, wherein the at least one transparent surface is formed out of a material adequate to constitute protective eyewear; and
a frame for holding the at least one transparent surface in front of the eyes of the user;
wherein the at least one transparent surface comprises a left 3D lens for disposition before the left eye of the user and a right 3D lens for disposition before the right eye of the user.

### REFERENCE TO PENDING PRIOR PATENT APPLICATION

This patent application claims benefit of pending prior U.S. Provisional Patent Application Ser. No. 61/313,213, filed Mar. 12, 2010 by John E. Kennedy for PROTECTIVE EYEWEAR INCORPORATING 3D LENSES FOR USE WITH ENDOSCOPIC 3D VISUALIZATION SYSTEM (Attorney's Docket No. VIKING-1 PROV), which patent application is hereby incorporated herein by reference.

### FIELD OF THE INVENTION

This invention relates to three dimensional (3D) visualization systems in general, and more particularly to eyewear for use in connection with 3D visualization systems.

### BACKGROUND OF THE INVENTION

Endoscopic visualization systems are well known in the art. In general, such systems comprise an endoscopic camera for acquiring images at a remote site within the body, and a monitor for displaying those images to a doctor, whereby to enable the doctor to perform a procedure at the remote site.

More recently, interest has grown in providing endoscopic 3D visualization systems, whereby to provide more lifelike images to the doctor.

In one exemplary endoscopic 3D visualization system, and looking now at FIG. 1, a stereo endoscope 5 and an associated 3D camera 10 are used to acquire stereo images from a remote site within the body of a patient, and these stereo images are fed to a 3D monitor 15. Specifically, the images from the left sensor of the 3D camera are displayed on the odd lines of the 3D monitor, and the images from the right sensor of the 3D camera are displayed on the even lines of the monitor. The 3D monitor utilizes a micro polarization technique in which odd lines are circular clockwise polarized and even lines are circular counter-clockwise polarized. The observer wears appropriately polarized eyewear 20 (i.e., the left lens 25 is circular clockwise polarized and the right lens 30 is circular counter-clockwise polarized) so that the left eye sees only the odd lines on the monitor (and hence only the images from the left sensor of the 3D camera) and the right eye sees only the even lines on the monitor (and hence only the images from the right sensor of the 3D camera). In this way, the endoscopic 3D visualization system can provide a stereoscopic effect for the observer.

Thus, with the aforementioned endoscopic 3D visualization system, it is necessary for the doctor to wear appropriately polarized eyewear 20 in order to obtain the stereoscopic effect of the 3D visualization system.

Other endoscopic 3D visualization systems are known in the art which rely on principles other than polarization to display the images from the left sensor of the 3D camera to the left eye of the viewer and to display the images from the right sensor of the 3D camera to the right eye of the viewer. All of these systems rely on the use of some type of 3D eyewear working in conjunction with appropriate displays.

By way of example but not limitation, some endoscopic 3D visualization systems use color filtration to display the images from the left sensor of the 3D camera to the left eye of the viewer and to display the images from the right sensor of the 3D camera to the right eye of the viewer. In this situation, the 3D eyewear maintains an appropriate color filter, or “lens”, in front of the left eye of the viewer and maintains a different appropriate color filter, or “lens”, in front of the right eye of the viewer.

By way of further example but not limitation, some endoscopic 3D visualization systems use liquid crystal shutters to display the images from the left sensor of the 3D camera to the left eye of the viewer and to display the images from the right sensor of the 3D camera to the right eye of the viewer. In this situation, the 3D eyewear is used to maintain an appropriate liquid crystal shutter, or “lens”, in front of the left eye of the viewer and another appropriate (but separately timed) liquid crystal shutter, or “lens”, in front of the right eye of the viewer.

Thus, with known endoscopic 3D visualization systems, it is necessary for the doctor to wear appropriate 3D eyewear in order to obtain the desired effects of the 3D visualization system.

It has been recognized that it can be inconvenient for the doctor to wear additional eyewear (i.e., eyewear in addition to the aforementioned 3D eyewear) when viewing the 3D display.

However, it has also been recognized that in the United States, the Occupational Safety and Health Administration (OSHA) requires the wearing of protective eyewear in the operating room.

The need to simultaneously wear both protective eyewear and 3D eyewear is, at best, inconvenient for the doctor, and in some cases can actually interfere with proper visualization of the remote site via the endoscopic 3D visualization system. By way of example but not limitation, simultaneously wearing both protective eyewear and 3D eyewear can create larger visual “blind spots” where the frame of the protective eyewear and the frame of the 3D eyewear block the field of vision of the doctor, and/or the serial disposition of multiple lenses (i.e., protective lenses and 3D lenses) in front of the eyes of the doctor can create issues with reflections, etc.

The present invention is intended to address the problems associated with simultaneously wearing both protective eyewear and 3D eyewear.

### SUMMARY OF THE INVENTION

The present invention comprises the provision and use of a novel form of protective eyewear. More particularly, the present invention comprises the provision and use of novel protective eyewear which incorporates 3D lenses in place of the standard clear lenses normally provided with required protective eyewear, such that the new protective eyewear can be used with an endoscopic 3D visualization system of the sort discussed above.

In one preferred form of the invention, there is provided protective eyewear for protecting the eyes of a user, the protective eyewear comprising:

at least one transparent surface for disposition in front of the eyes of the user, wherein the at least one transparent surface is formed out of a material adequate to constitute protective eyewear; and

a frame for holding the at least one transparent surface in front of the eyes of the user;

wherein the at least one transparent surface comprises a left 3D lens for disposition before the left eye of the user and a right 3D lens for disposition before the right eye of the user.

In another preferred form of the invention, there is provided a system for enabling 3D visualization of an object, the system comprising:

a 3D monitor for presenting a 3D image of an object; and

protective eyewear for protecting the eyes of a user, the protective eyewear comprising:
at least one transparent surface for disposition in front of the eyes of the user, wherein the at least one transparent surface is formed out of a material adequate to constitute protective eyewear; and
a frame for holding the at least one transparent surface in front of the eyes of the user;
wherein the at least one transparent surface comprises a left 3D lens for disposition before the left eye of the user and a right 3D lens for disposition before the right eye of the user.

In another preferred form of the invention, there is provided a method for enabling 3D visualization of an object, the method comprising:

providing a 3D monitor for presenting a 3D image of an object, and providing protective eyewear for protecting the eyes of a user, the protective eyewear comprising:
at least one transparent surface for disposition in front of the eyes of the user, wherein the at least one transparent surface is formed out of a material adequate to constitute protective eyewear; and
a frame for holding the at least one transparent surface in front of the eyes of the user;
wherein the at least one transparent surface comprises a left 3D lens for disposition before the left eye of the user and a right 3D lens for disposition before the right eye of the user;

presenting a 3D image of an object on the 3D monitor; and

viewing the 3D image presented on the 3D monitor through the protective eyewear.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view of a prior art endoscopic 3D visualization system;

FIG. 2 is a schematic view of protective eyewear, in the form of glasses, incorporating 3D lenses for use with an endoscopic 3D visualization system; and

FIG. 3 is a schematic view of protective eyewear, in the form of a face shield, incorporating 3D lenses for use with an endoscopic 3D visualization system.

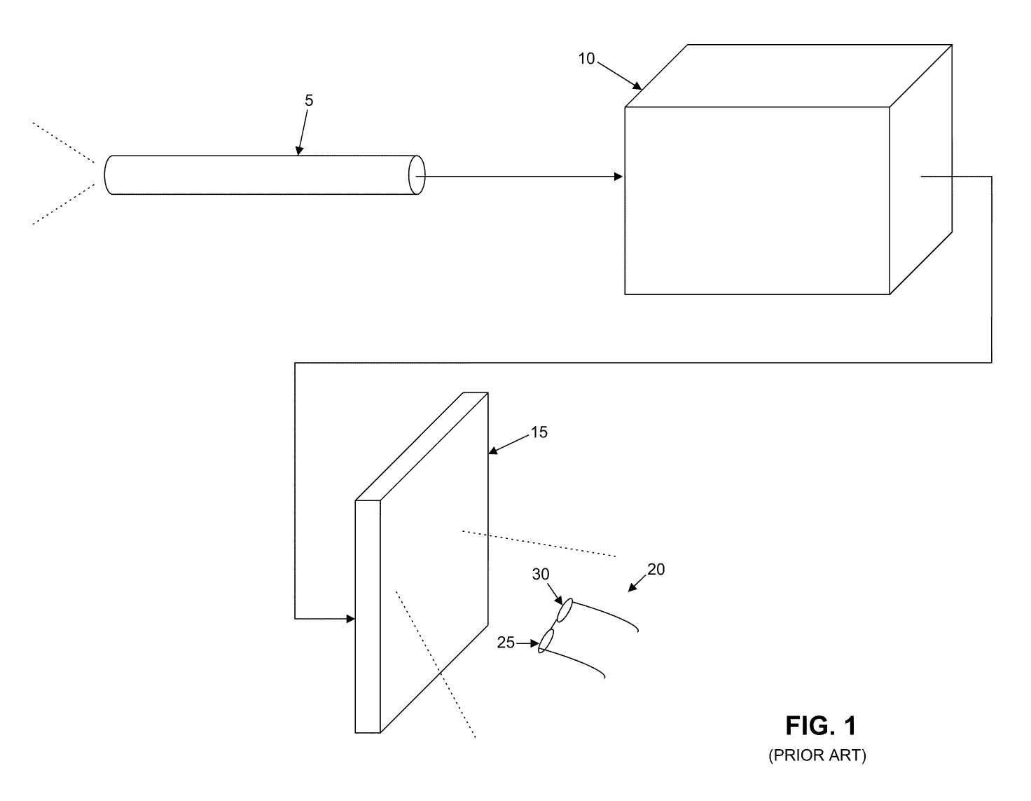

### DETAILED DESCRIPTION OF THE PREFERRED EMBODIMENTS

The present invention comprises the provision and use of a novel form of protective eyewear. More particularly, the present invention comprises the provision and use of novel protective eyewear which incorporates 3D lenses in place of the standard clear lenses normally provided with required protective eyewear, such that the new protective eyewear can be used with an endoscopic 3D visualization system of the sort discussed above.

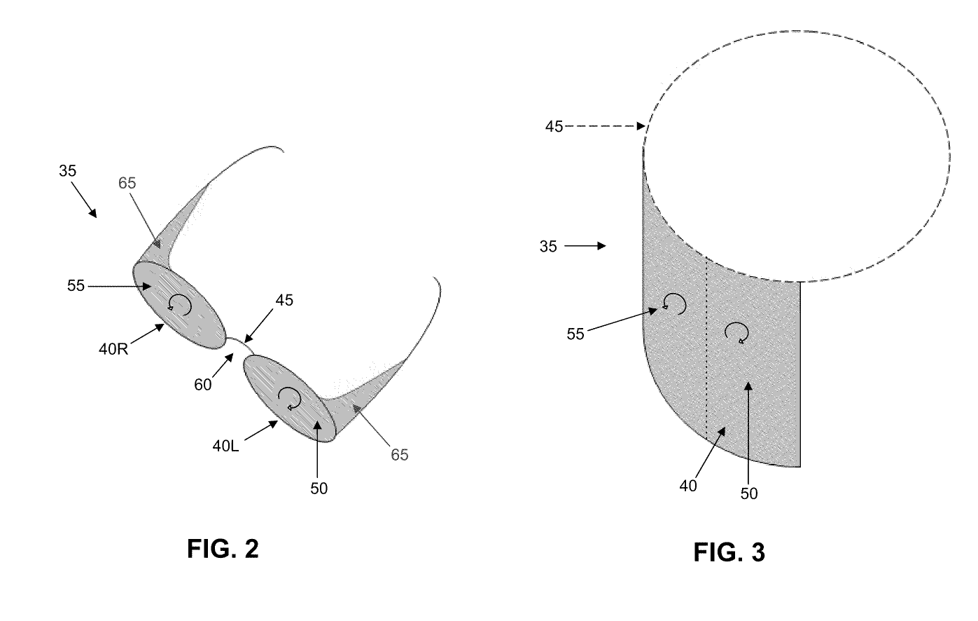

More particularly, and looking now at FIG. 2, there is shown protective eyewear 35 comprising at least one transparent surface 40 for disposition in front of the eyes of the user, wherein the at least one transparent surface 40 is formed out of a material adequate to constitute protective eyewear (e.g., an impact-resistant material), and a protective frame 45 for holding the at least one transparent surface in front of the eyes of the user. The at least one transparent surface 40 comprises a left 3D lens 50 for disposition before the left eye of the user and a right 3D lens 55 for disposition before the right eye of the user. It will be seen that in the embodiment shown in FIG. 2, the at least one transparent surface 40 comprises a first transparent surface 40L and a second transparent surface 40R, wherein first transparent surface 40L and second transparent surface 40R are separated by a gap 60, and further wherein the first transparent surface 40L comprises the left 3D lens 50 and the second transparent surface 40R comprises the right 3D lens 55. Protective frame 45 is preferably formed out of an impact-resistant material (e.g., high impact plastic), and protective frame 45 preferably comprises side guards 65 of increased surface area so as to provide protection against fluid splashes and the like.

Preferably, the left 3D lens 50 and the right 3D lens 55 comprise polarizers. In one preferred form of the present invention, these polarizers comprise circular polarizers such that the left 3D polarizer is configured to polarize light in one of a clockwise or counterclockwise direction, and the right 3D polarizer is configured to polarize light in the other of a clockwise or counterclockwise direction. The particular direction of such polarization is coordinated with the polarization presented on the 3D monitor 15 so that the images from the left sensor of the 3D camera are presented to the left eye of the user and the images from the right sensor of the 3D camera are presented to the right eye of the user.

Thus, for example, the left image may be displayed on the odd lines of the monitor, the odd lines may be polarized clockwise, and left 3D lens 50 of protective eyewear 35 may be polarized clockwise; and correspondingly, the right image may be displayed on the even lines of the monitor, the even lines may be polarized counterclockwise, and right 3D lens 55 of protective eyewear 35 may be polarized counterclockwise. However, if desired, this arrangement could be reversed, or otherwise modified—the important point is that the left image should be presented to the left eye (and only the left eye), and the right image should be presented to the right eye (and only the right eye), and various arrangements of polarization may be used to achieve this effect.

If desired, the polarizers may comprise linear polarizers, where left 3D lens 50 is configured to polarize light a first linear direction, and right 3D lens 55 is configured to polarize light in a second, linear direction, wherein the second linear direction is orthogonal to the first linear direction. Again, the directions of such polarization is coordinated with the polarization presented on the 3D monitor 15 so that the images from the left sensor of the 3D camera are presented to the left eye of the user and the images from the right sensor of the 3D camera are presented to the right eye of the user.

FIG. 3 shows another preferred embodiment of the present invention. In this form of the invention, the at least one transparent surface 40 comprises a face shield (sized for full or partial shielding of the face) and left 3D lens 50 and right 3D lens 55 comprise regions of the face shield. In one preferred form of the present invention, left 3D lens 50 comprises the left half of the face shield and right 3D lens 55 comprises the right half of the face shield.

It should be appreciated that the present invention can also be incorporated in protective eyewear of the type which is designed to be worn over prescription eyeglasses (i.e., the 3D lenses can be incorporated in protective “over-the-glasses” eyewear).

Furthermore, the present invention can be incorporated in protective eyewear which comprises prescription lenses (i.e., the 3D lenses are combined with prescription lenses in the protective eyewear).

The present invention can also be utilized in conjunction with endoscopic 3D visualization systems which rely on principles other than polarization to display the images from the left sensor of the 3D camera to the left eye of the viewer and to display the images from the right sensor of the 3D camera to the right eye of the viewer.

By way of example but not limitation, with an endoscopic 3D visualization system which uses color filtration to display the images from the left sensor of the 3D camera to the left eye of the viewer and to display the images from the right sensor of the 3D camera to the right eye of the viewer, the novel protective eyewear incorporates appropriate 3D lenses (i.e., appropriate color filters) for this type of system.

By way of further example but not limitation, with an endoscopic 3D visualization system which uses liquid crystal shutters to display the images from the left sensor of the 3D camera to the left eye of the viewer and to display the images from the right sensor of the 3D camera to the right eye of the viewer, the novel protective eyewear incorporates appropriate 3D lenses (i.e., appropriate liquid crystal shutters) for this type of system.

The material used to form the at least one transparent surface 40 (i.e., first transparent surface 40L and second transparent surface 40R in the construction shown in FIG. 2, and/or the face shield in the construction shown in FIG. 3) may be any material consistent with the intent and function of the present invention, i.e., able to serve as a transparent protective barrier in front of the eyes of the user and able to carry left 3D lens 50 and right 3D lens 55. By way of example, but not limitation, the at least one transparent surface 40 may comprise an impact resistant plastic (e.g., a high impact plastic) with appropriate optical characteristics.

### Other Applications

It should be appreciated that the present invention may be used in other types of 3D visualization systems (i.e., non-endoscopic 3D visualization systems) where it is mandatory or desirable to wear protective eyewear while utilizing the 3D visualization system. By way of example but not limitation, the present invention may be used in connection with a 3D visualization system for visualizing the interior of a jet engine.

### Modifications

While the present invention has been described in terms of certain exemplary preferred embodiments, it will be readily understood and appreciated by one of ordinary skill in the art that it is not so limited, and that many additions, deletions and modifications may be made to the preferred embodiments discussed above while remaining within the spirit and scope of the present invention.

What is claimed is:

1. Protective eyewear for protecting the eyes of a user, the protective eyewear comprising:
at least one transparent surface for disposition in front of the eyes of the user, wherein the at least one transparent surface is formed out of a material adequate to constitute protective eyewear; and
a frame for holding the at least one transparent surface in front of the eyes of the user;
wherein the at least one transparent surface comprises a left 3D lens for disposition before the left eye of the user and a right 3D lens for disposition before the right eye of the user.

2. Protective eyewear according to claim 1 wherein the at least one transparent surface comprises a first transparent surface and a second transparent surface, wherein the first transparent surface and the second transparent surface are separated by a gap, and further wherein the first transparent surface comprises the left 3D lens and the second transparent surface comprises the right 3D lens.

3. Protective eyewear according to claim 1 wherein the at least one transparent surface comprises a face shield, and further wherein the left 3D lens and the right 3D lens comprise regions of the face shield.

4. Protective eyewear according to claim 1 wherein the left 3D lens and the right 3D lens comprise polarizers.

5. Protective eyewear according to claim 4 wherein the polarizers comprise circular polarizers.

6. Protective eyewear according to claim 5 wherein the left 3D polarizer is configured to polarize light in one of a clockwise or counterclockwise direction, and the right 3D polarizer is configured to polarize light in the other of a clockwise or counterclockwise direction.

7. Protective eyewear according to claim 4 wherein the polarizers comprise linear polarizers.

8. Protective eyewear according to claim 7 wherein the left 3D polarizer is configured to polarize light a first linear direction, and the right 3D polarizer is configured to polarize light in a second linear direction, wherein the second linear direction is orthogonal to the first linear direction.

9. Protective eyewear according to claim 1 wherein the left 3D lens and the right 3D lens comprise color filters.

10. Protective eyewear according to claim 1 wherein the left 3D lens and the right 3D lens comprise liquid crystal shutters.

11. Protective eyewear according to claim 1 wherein the least one transparent surface is formed out of an impact-resistant material.

12. Protective eyewear according to claim 11 wherein the impact-resistant material comprises high impact plastic.

13. Protective eyewear according to claim 1 wherein the least one transparent surface further comprises at least one prescription lens.

14. Protective eyewear according to claim 13 wherein the at least one prescription lens is physically combined with at least one of the left 3D lens and the right 3D lens.

15. Protective eyewear according to claim 1 wherein the frame is configured to be worn over prescription eyewear.

16. Protective eyewear according to claim 1 wherein the frame is formed out of an impact-resistant material.

17. Protective eyewear according to claim 16 wherein the impact-resistant material comprises high impact plastic.

18. Protective eyewear according to claim 1 wherein the frame comprises side splash guards.

19. A system for enabling 3D visualization of an object, the system comprising:
a 3D monitor for presenting a 3D image of an object; and
protective eyewear for protecting the eyes of a user, the protective eyewear comprising:
at least one transparent surface for disposition in front of the eyes of the user, wherein the at least one transparent surface is formed out of a material adequate to constitute protective eyewear; and
a frame for holding the at least one transparent surface in front of the eyes of the user;
wherein the at least one transparent surface comprises a left 3D lens for disposition before the left eye of the user and a right 3D lens for disposition before the right eye of the user.

20. A system according to claim 19 wherein the at least one transparent surface comprises a first transparent surface and a second transparent surface, wherein the first transparent surface and the second transparent surface are separated by a gap, and further wherein the first transparent surface comprises the left 3D lens and the second transparent surface comprises the right 3D lens.

21. A system according to claim 19 wherein the at least one transparent surface comprises a face shield, and further wherein the left 3D lens and the right 3D lens comprise regions of the face shield.

22. A system according to claim 19 wherein the left 3D lens and the right 3D lens comprise polarizers.

23. A system according to claim 22 wherein the polarizers comprise circular polarizers.

24. A system according to claim 23 wherein the left 3D polarizer is configured to polarize light in one of a clockwise or counterclockwise direction, and the right 3D polarizer is configured to polarize light in the other of a clockwise or counterclockwise direction.

25. A system according to claim 22 wherein the polarizers comprise linear polarizers.

26. A system according to claim 25 wherein the left 3D polarizer is configured to polarize light a first linear direction, and the right 3D polarizer is configured to polarize light in a second linear direction, wherein the second linear direction is orthogonal to the first linear direction.

27. A system according to claim 19 wherein the left 3D lens and the right 3D lens comprise color filters.

28. A system according to claim 19 wherein the left 3D lens and the right 3D lens comprise liquid crystal shutters.

29. A method for enabling 3D visualization of an object, the method comprising:
providing a 3D monitor for presenting a 3D image of an object, and providing protective eyewear for protecting the eyes of a user, the protective eyewear comprising:
at least one transparent surface for disposition in front of the eyes of the user, wherein the at least one transparent surface is formed out of a material adequate to constitute protective eyewear; and
a frame for holding the at least one transparent surface in front of the eyes of the user;
wherein the at least one transparent surface comprises a left 3D lens for disposition before the left eye of the user and a right 3D lens for disposition before the right eye of the user;
presenting a 3D image of an object on the 3D monitor; and
viewing the 3D image presented on the 3D monitor through the protective eyewear.
